(19) United States
(12) Patent Application Publication
(10) Pub. No.: US 2024/0034471 A1
(43) Pub. Date: Feb. 1, 2024

(54) Providing Electronic Sponsor Pages Through an Inflight Interactive Environment Onboard an Aircraft

(71) Applicant: ViaSat, Inc., Carlsbad, CA (US)

(72) Inventors: Fergal Murray, Tomhaggard (IE); Niall O'Sullivan, Dundrum (IE); Ultan O'Brien, Carrickmines (IE)

(21) Appl. No.: 18/245,871

(22) PCT Filed: Sep. 17, 2020
(86) PCT No.: PCT/US20/51214

§ 371 Date: Mar. 17, 2023

(51) Int. Cl. B64D 11/00; H04N 21/81

(52) U.S. Cl. CPC B64D 11/00155; H04N 21/812

(57) ABSTRACT

Technology is described for providing electronic sponsor pages to passengers on an aircraft. An interface control and an inflight interactive environment may be combined at a server on the aircraft. The interface control may be associated with an electronic sponsor page and may enable a passenger on the aircraft to access the electronic sponsor page through the inflight interactive environment. The inflight interactive environment may be sent from the server to a client device onboard the aircraft over a network connection for display on the client device. A selection of the interface control included in the inflight interactive environment may be received. The electronic sponsor page may be sent from the server to the client device for display. The electronic sponsor page may include a sub-interface enabling access to one or more electronic objects.

### BACKGROUND

In-flight entertainment (IFE) and information systems may provide entertainment, moving map information, flight information, or other information to aircraft passengers during a flight. IFE systems may include centralized display monitors, seat back display monitors and/or connections for personal electronic devices via a wireless network, which may enable aircraft passengers to consume audio content, video content, moving map information, electronic games, etc. The media content may include music, news, comedy, moving map information, flight information, travel information, etc. Such video content may include television programs, movies, live television programs (e.g., live news programs, live sporting events), cable programs, etc. Moving map information may provide real-time flight information. For example, the moving map information may provide a map that illustrates a current position and direction of the aircraft, as well as other information about the flight (e.g., altitude, airspeed, outside air temperature, distance to destination, distance from origination point, local time, etc.)

In one example, IFE systems may provide in-flight network connectivity to personal electronic devices, such as mobile phones, laptops or tablet computers. For example, IFE systems may allow aircraft passengers to consume audio content, video content, games, maps, etc. using personal electronic devices. The personal electronic devices may receive the audio content, video content, games, maps, shopping, etc. from a server onboard the aircraft via a wireless access point (e.g., a Wi-Fi access point) in the aircraft. Further, IFE systems may provide in-cabin internet service, which may enable aircraft passengers to perform activities, such as internet browsing, media viewing, texting, messaging, emailing, etc. using personal electronic devices. In-flight internet service may be provided through a satellite network in communication with communications hardware on the aircraft that enables aircraft passengers to connect to the internet from personal electronic devices via the wireless access point.

### SUMMARY

A method for providing electronic sponsor pages to passengers on an aircraft is provided. The method may include combining, at a server on the aircraft, an interface control and an inflight interactive environment, wherein the interface control is associated with an electronic sponsor page and enables a passenger on the aircraft to access the electronic sponsor page through the inflight interactive environment via a user interface. The method may include sending the inflight interactive environment from the server to a client device onboard the aircraft over a network connection for display via the user interface of the client device. The method may include receiving, at the server, a selection of the interface control included in the inflight interactive environment via the user interface. The method may include sending, in response to the selection of the interface control, the electronic sponsor page from the server to the client device for display, wherein the electronic sponsor page includes a sub-interface enabling access to one or more electronic objects.

A non-transitory machine readable storage medium having instructions embodied thereon is provided. The instructions when executed by one or more processors, cause the one or more processors to perform a process. The process may include receiving, at a server on an aircraft, an electronic sponsor page that includes one or more electronic objects. The process may include combining, at the server, an interface control and an inflight interactive environment, wherein the interface control is associated with the electronic sponsor page and enables a passenger on the aircraft to access the electronic sponsor page through the inflight interactive environment via a user interface. The process may include storing the inflight interactive environment that includes the interface control on a data store that resides on the aircraft. The process may include sending, from the server, the inflight interactive environment to a client device onboard the aircraft over a network connection for display via the user interface of the client device, wherein the electronic sponsor page is accessible through the interface control included in the inflight interactive environment. The process may include sending, in response to a selection of the interface control, the electronic sponsor page from the server to the client device for display via the user interface, wherein the electronic sponsor page includes a sub-interface enabling access to the one or more electronic objects.

A system is provided that may include at least one processor and at least one memory device including a data store to store a plurality of data and instructions. The plurality of data and instructions, when executed, cause the system to combine an interface control and an inflight interactive environment, wherein the interface control is associated with an electronic sponsor page and enables a passenger on an aircraft to access the electronic sponsor page through the inflight interactive environment via a user interface. The plurality of data and instructions, when executed, cause the system to send the inflight interactive environment to a client device onboard an aircraft over a network connection for display via the user interface of the client device. The plurality of data and instructions, when executed, cause the system to receive a selection of the interface control included in the inflight interactive environment via the user interface. The plurality of data and instructions, when executed, cause the system to send, in response to the selection of the interface control, the electronic sponsor page to the client device for display, wherein the electronic sponsor page includes a sub-interface enabling access to one or more electronic objects.

### BRIEF DESCRIPTION OF THE DRAWINGS

FIG. 1A is a block diagram illustrating a system for providing an inflight interactive environment which enables access to an electronic sponsor page according to an example of the present technology.

FIG. 1B is a block diagram illustrating a system and related operations for providing an inflight interactive environment and an electronic sponsor page accessible from a computing provider environment according to an example of the present technology.

FIG. 2 is a block diagram illustrating a system and related operations for collecting passenger information through an electronic sponsor page and providing the passenger information to a server in a computing provider environment according to an example of the present technology.

FIG. 3A illustrates a user interface that enables a user to access an inflight interactive environment and an electronic sponsor page according to an example of the present technology.

FIG. 3B illustrates a sub interface that enables a user to access an electronic sponsor page according to an example of the present technology.

FIG. 4A illustrates a user interface that enables a user to access an inflight interactive environment and an electronic sponsor page according to an example of the present technology.

FIG. 4B illustrates a sub interface that enables a user to access an electronic sponsor page according to an example of the present technology.

FIG. 5 is a flowchart of an example method for providing an electronic sponsor page to passengers on an aircraft.

FIG. 6 is a flowchart of another example method for providing an electronic sponsor page to passengers on an aircraft.

FIG. 7 is a satellite communication system according to an example of the present technology.

FIG. 8 is a block diagram that provides an example illustration of a computing device that may be employed in the present technology.

### DETAILED DESCRIPTION

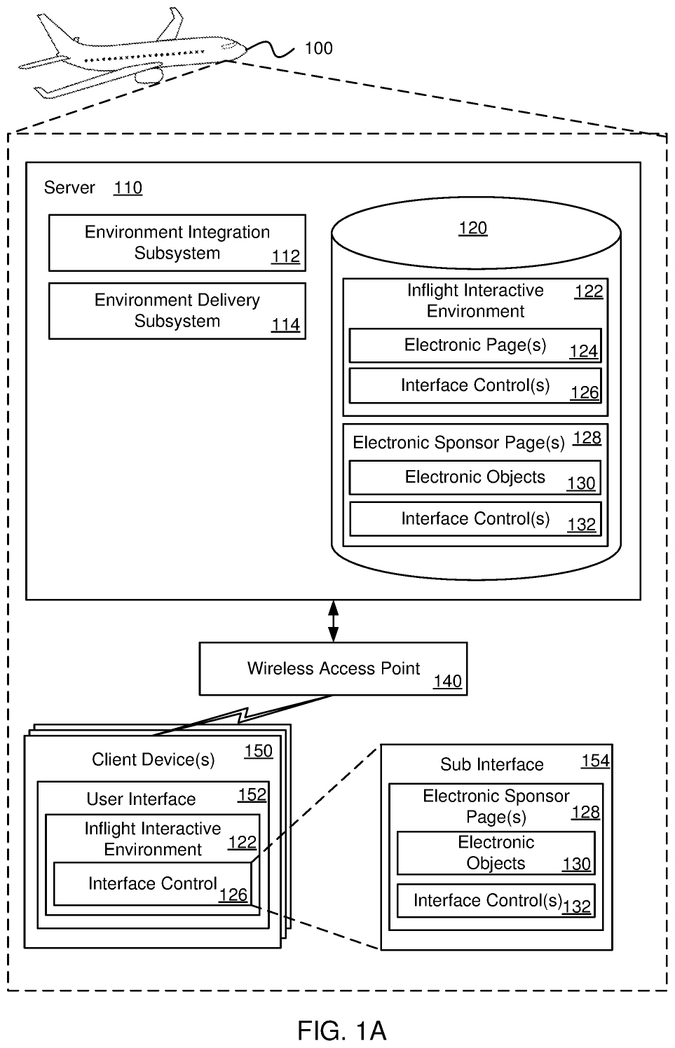

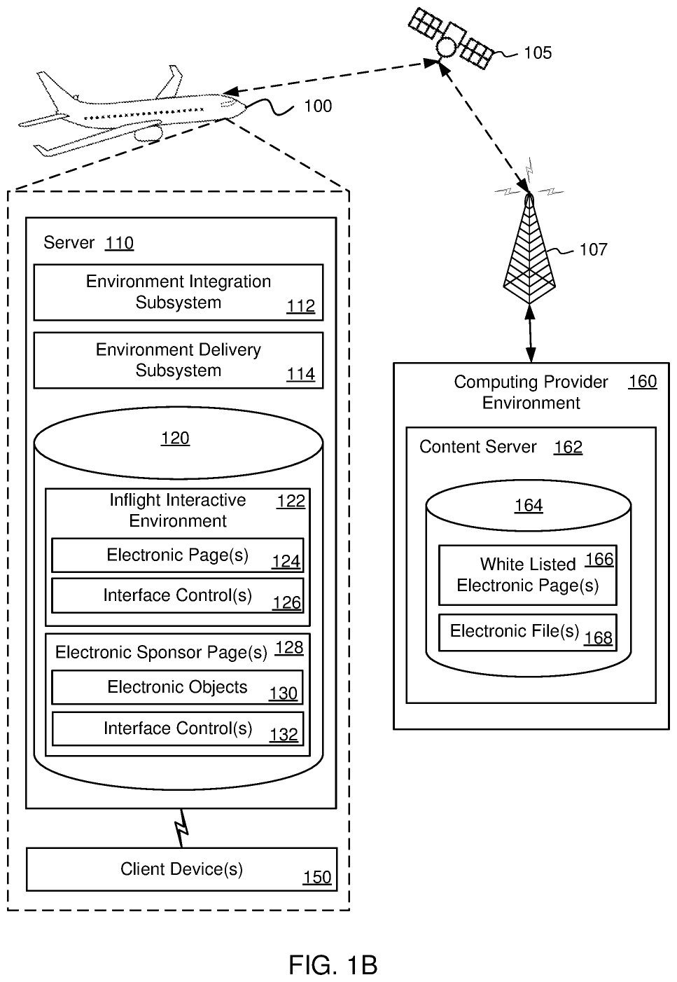

FIG. 1A illustrates an example of a system for providing an inflight interactive environment 122, having an interface control 126 to access an electronic sponsor page 128, to a client device 150 on an aircraft 100. The aircraft 100 may be one of multiple aircraft which are included in a fleet of aircraft. A server 110 onboard the aircraft 100 may provide a user interface 152 to the client device 150. The user interface 152 may enable access to both the inflight interactive environment 122 and the electronic sponsor page 128. The inflight interactive environment 122 may include a plurality of electronic pages 124 (e.g., web pages or application pages) which may enable a user or passenger on the aircraft 100 to watch movies and television programs, listen to audio, play electronic games, browse shopping electronic pages, etc. The inflight interactive environment 122 may include the interface control 126 to access the electronic sponsor page 128. The interface control 126 may be a graphical user interface (GUI) control, including but not limited to, an electronic link, a tab, a button, menu item, etc., where the interface control 126 may be used to access the electronic sponsor page 128. The electronic sponsor page 128 may include a plurality of electronic objects 130 (e.g., electronic links, web pages, application pages, text, images, audio or video, apps, animations, plugins, etc.) and/or interface controls 132, and the electronic sponsor page 128 may be associated with a sponsor. The sponsor may be an individual, company, organization, etc. that pays a monetary value to have their content available for access through the inflight interactive environment 122. For example, the electronic sponsor page 128 may include access to sponsor media content, sponsor shopping, sponsor information about a product or service, etc., and the content accessible through the electronic sponsor page 128 may be owned and/or operated by the sponsor. In addition, the electronic sponsor page 128 may be accessible through a sub interface 154 provided to the client device 150.

The client device 150 may be a personal electronic device, such as a mobile phone or a tablet computer, and a network connection between the client device 150 and the server 110 may be a wireless connection established via the wireless access point 140. In another example, the client device 150 may be a seatback system installed on a passenger seat of the aircraft 100, and a network connection between the client device 150 and the server 110 may be a wired or wireless connection.

In the examples described herein, the techniques described are described in the context of an aircraft. Alternatively, the techniques described for providing the electronic sponsor page 128 may be provided to a client device 150 on another type of mobile platform, such as a ship, bus, train, etc.

In one example, an environment integration subsystem 112 of the server 110 may receive the electronic objects 130 and interface controls 132 from the sponsor. The electronic objects 130 may be selected by the sponsor and may include, but are not limited to: electronic links, web pages, application pages, text, images, audio, animations, games, or video. The environment integration subsystem 112 may combine or integrate the electronic objects 130 and the interface controls 132 received from the sponsor in the electronic sponsor page 128. In other words, the environment integration subsystem 112 may create the electronic sponsor page 128 by including the electronic objects 130 and the interface controls 132 received from the sponsor. The interface controls 132 included on the electronic sponsor page 128 may include electronic links or electronic interfaces to access content stored off-board the aircraft 100. For example, the interface controls 132 may be to access white listed electronic pages (e.g., web pages) stored on a content server off-board the aircraft 100. As another example, the interface controls 132 may be to access a function, a service, a web application or an electronic file provided by the white listed electronic page stored on the content server off-board the aircraft 100. Non-limiting examples of electronic files that are stored off-board the aircraft 100 may include media files, executable files, word processor documents, image files, database file or spreadsheet files, presentation files, video files, audio files, animation files, etc.

Further, the environment integration subsystem 112 may combine the interface control(s) 126 to access the electronic sponsor page 128 and the inflight interactive environment 122. In other words, the environment integration subsystem 112 may integrate the interface control(s) 126 into the inflight interactive environment 122 and make the electronic sponsor page 128 accessible through the interface control(s) 126 included in the inflight interactive environment 122 using the user interface 152. The environment integration subsystem 112 may store the inflight interactive environment 122 that includes the interface controls 126 and the electronic sponsor page 128 in a data store 120 that resides on the aircraft 100. In other words, in this example, the inflight interactive environment 122 and the electronic sponsor page 128 may be stored locally on the aircraft 100, as opposed to being stored on a server off-board the aircraft 100. As a result, the inflight interactive environment 122 and the electronic sponsor page 128 may be accessible through the user interface 152 to users when the aircraft 100 is in the air.

In one example, an environment delivery subsystem 114 of the server 110 may send or transmit the inflight interactive environment 122 to the client device 150 onboard the aircraft 100. The environment delivery subsystem 114 may transmit the inflight interactive environment 122 over the wireless access point 140 to the client device 150. The inflight interactive environment 122 may include the plurality of electronic pages 124. The electronic pages 124 may include interface controls to access a home screen, media content, shopping information, moving map information and/or destination information. The electronic pages 124 may be displayed on the user interface 152 provided to the client device 150. Further, the electronic pages 124 may include the interface controls 126 to access the electronic sponsor page 128. For example, an electronic page 124 in the plurality of electronic pages 124 may include the interface control 126 to access the electronic sponsor page 128. As a non-limiting example, the interface control 126 to access the electronic sponsor page 128 may be an electronic link, such as a text link, an image link, a video link, etc., which when selected through the user interface 152, may allow access to the electronic sponsor page 128 (or open the electronic sponsor page 128).

In one example, the server 110 may receive the selection of the electronic sponsor page 128 from the client device 150. The environment delivery subsystem 114 of the server 110 may send or transmit the electronic sponsor page 128 to the client device 150. The environment delivery subsystem 114 may transmit the electronic sponsor page 128 over the wireless access point 140 to the client device 150. The electronic sponsor page 128 may include the electronic objects 130 and/or the interface controls 132. The electronic sponsor page 128 may be displayed through the sub interface 154 provided to the client device 150. In other words, the electronic objects 130 and/or the interface controls 132 included on the electronic sponsor page 128 may be accessed via the sub interface 154 displayed on the client device 150. Further, the electronic sponsor page 128 may be accessible to users on the aircraft 100 for a defined duration of time based on a marketing campaign duration set by the sponsor affiliated with the electronic sponsor page 128. The defined duration of time may refer to a total time period, such as a period of three months, or a specific time period within a flight, such as a time period spanning from after take-off to before landing of the flight.

In one example, the sub interface 154 may be displayed as an overlay on the user interface 152. For example, selecting the interface control 126 on the inflight interactive environment 122 displayed through the user interface 152 may cause the electronic sponsor 154 may be an overlay or displayed on top of the user interface 152. In another example, selecting the interface control 126 on the inflight interactive environment 122 may cause the electronic sponsor page 128 to be opened through the sub interface 154, thereby replacing the user interface 152. In either examples, closing or exiting from the sub interface 154 may cause the inflight interactive environment 122 to be redisplayed through the user interface 152.

As a non-limiting example, the user may be watching a movie through the inflight interactive environment 122. The movie may be displayed via the user interface 152. On the corner of the user interface 152, a selectable icon, tab, button or electronic link may be displayed. In this example, the icon may be an image of a credit card offered by a banking institution. In this example, the icon may be a promotion for a credit card offered by that banking institution. The user may pause the movie and select the icon using the user interface 152. Upon selection of the icon, an electronic sponsor page 128 associated with that banking institution may be displayed. More specifically, a sub interface 154 may be displayed as an overlay to the user interface 152, and the sub interface 154 may include additional details relating to the credit card promotion being offered by the banking institution. In this particular example, the banking institution may be sponsoring or promoting the electronic sponsor page 128 on the aircraft 100 over a duration of two months as part of a marketing campaign run by the banking institution. The user may navigate through various electronic pages or electronic objects 130 on the electronic sponsor page 128 via the sub interface 154. For example, the user may read more about the credit card promotion, provide personal details (e.g., name, electronic mail address, phone number) for signing up for the credit card, etc. via the sub interface 154. When the user is finished reading or interacting with the electronic sponsor page 128, the user may close the electronic sponsor page 128 and exit out of the sub interface 154, thereby returning to the movie being played on the inflight interactive environment 122 via the user interface 152.

In one configuration, the electronic sponsor page 128 may be activated or enabled to be accessed through the interface control 126 depending on route characteristics of a route of the aircraft 100 or when a predefined event occurs. Route characteristics may describe the route of the aircraft (a geographic location over which the aircraft is located (e.g., a country)), may include an origin of the aircraft 100, a destination of the aircraft 100, etc. The predefined event may be the aircraft 100 reaching the certain altitude (e.g., 10,000 feet). In another example, the predefined event may be the aircraft 100 reaching a certain location (e.g., international air space). The electronic sponsor page 128 may be associated with a casino, a retailer that is offering duty free products, a regional media streaming service, etc.

In one example, the electronic sponsor page 128 may be an activation page to describe to users on the aircraft 100 a product or a service offered by the sponsor. The activation page may serve to educate the users or attract the users to the product or service. In other words, the activation page may function to activate user interest in the product or service offered by the sponsor. As a non-limiting example, the activation page may describe banking services or electronic devices offered by the sponsor affiliated with the electronic sponsor page 128. In another example, the electronic sponsor page 128 may be an acquisition page to acquire users on the aircraft 100 as new customers of the sponsor. As another non-limiting example, the acquisition page may attempt to acquire new users or subscribers to a video streaming service or a music streaming service offered by the sponsor affiliated with the electronic sponsor page 128. The electronic sponsor page 128 may be an activation page or an acquisition page depending on the business goals of the sponsor or the type of industry in which the sponsor operates.

In one example, a wireless connection between the server 110 and the client device(s) 150 may be established using Transmission Control Protocol/Internet Protocol (TCP/IP), and services in the server 110 may be web services that are RESTful. The wireless access point 140 that facilitates data traffic between the server, the client device(s) 150 may operate using a Wi-Fi protocol, a Bluetooth protocol or another appropriate wireless protocol.

The client device(s) 150 may comprise, for example, processor-based systems. The client device(s) 150 may be devices such as, but not limited to, laptops or notebook computers, tablet computers, mobile devices, handheld computers, or other devices with like capability. The client device(s) 150 may be mobile computing devices. The client device(s) 150 may be personal electronic devices or may be property of an aircraft operator. In another example, the client device(s) 150 may be seatback systems that are installed on passenger seats of the aircraft 100.

In one configuration, the server 110 may communicate with the client device(s) 150 via a network. The network may include any useful computing network, including a localized network, a wireless data network, or any other such network or combination thereof. Components utilized for such a system may depend at least in part upon the type of network and/or environment selected. Communication over the network may be enabled by wired or wireless connections and combinations thereof.

The various processes and/or other functionality contained within the server(s) 110 may be executed on one or more processors that are in communication with one or more memory modules. The server(s) 110 may include a number of computing devices that are arranged, for example, in one or more server banks or computer banks or other arrangements.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

FIG. 1A illustrates that certain processing modules or subsystems may be discussed in connection with this technology. In one example configuration, a module or subsystem may be considered a service with one or more processes executing on a server or other computer hardware. For example, modules or subsystems providing services may be hosted in a server. An application programming interface (API) may be provided for each module or subsystem to enable a second module or subsystem to send requests to and receive output from a first module or subsystem. Such APIs may also allow third parties to interface with the module or subsystem and make requests and receive output from the modules or subsystems.

While FIG. 1A illustrates an example of a system that may implement the techniques above, many other similar or different environments are possible. The example environments discussed and illustrated above are merely representative and not limiting.

In the past, advertisers have had an ability to provide electronic advertisements for display on inflight entertainment systems. For example, such electronic advertisements may have been displayed prior to or during videos being played through the inflight entertainment system. In another example, such electronic advertisements may have been displayed when users viewed other types of content through the inflight entertainment system, such as menu content, shopping content, etc. However, in the past, advertisers have not had an ability to incorporate dedicated electronic page(s) into the inflight entertainment system. In other words, in the past, advertisers did not have an ability to create an independent customized channel or portal having a plurality of electronic sponsor pages containing advertiser content or sponsor content, and then have the ability to incorporate or integrate the electronic sponsor pages associated with the advertiser or sponsor with the inflight entertainment system on the aircraft.

In the present technology, an electronic sponsor page may be combined or integrated with an inflight entertainment system accessible on an aircraft. The inflight entertainment system may include interface control(s) to access the electronic sponsor page, where the electronic sponsor page may include content particular to the sponsor or advertiser affiliated with the electronic sponsor page. As a result, the sponsor may have the ability to design customized content to be included in the electronic sponsor page. The content included in the electronic sponsor page may include informational content, promotional content, media content (e.g., movies and television programs), shopping content, etc. based on the business goals of the sponsor or the type of industry in which the sponsor operates. In one example, the sponsor may negotiate a deal with an airline or aircraft operator to provide access to the electronic sponsor page through the inflight entertainment system for a certain duration of time (e.g., four months), and in return, the sponsor may provide compensation to the airline or aircraft operator. The airline or aircraft operator may receive the electronic sponsor page and its content, and then integrate the electronic sponsor page with the inflight entertainment system, such that the electronic sponsor page may be accessible through the inflight entertainment system via a user interface, which may be a unified, integrated or combined user interface.

FIG. 1B illustrates an example of a system and related operations for providing an inflight interactive environment 122 and an electronic sponsor page 128 having an interface control 132 to electronic pages 166 accessible through a computing provider environment 160. The computing provider environment 160 may include a public cloud environment, a private cloud environment, a data center, centralized hardware servers, a data warehouse, etc., and the computing provider environment 160 may be external to the aircraft 100. In this configuration, a content server 162 in the computing provider environment 160 may include a data store 164 of the electronic pages 166 accessible via the interface control(s) 132 on the electronic sponsor page 128. More specifically, the data store 164 of the electronic pages 166 may not be onboard the aircraft 100.

In one example, the interface controls 132 included in the electronic sponsor server 162 off-board the aircraft 100. For example, the white listed electronic pages 166 may be accessible to the client device 150 on the aircraft 100 via the electronic sponsor page 128 by using an internet connection available onboard the aircraft 100 when the aircraft 100 is in the air. In this example, users on the aircraft 100 may be allowed or permitted to access the white listed electronic pages 166 stored on the content server 162 via the internet connection available onboard the aircraft 100.

In another example, the interface controls 132 included in the electronic sponsor page 128 may be electronic links to electronic file(s) 168 or services provided by a white listed electronic page 166 stored on the content server 162 off-board the aircraft 100. For example, the electronic file(s) 168 may be accessible to the client device 150 on the aircraft 100 via the electronic sponsor page 128 by using the internet connection available onboard the aircraft 100 when the aircraft 100 is in the air. In this example, users on the aircraft 100 may be allowed or permitted to access the electronic file(s) 168 via the internet connection available onboard the aircraft 100. The electronic file(s) 168 stored on the content server 162 may include, but are not limited to, media files, executable files, word processor documents, image files, database or spreadsheet files, presentation files, video files, audio files, etc.

As a non-limiting example, the user of the client device 150 may select an electronic link on the electronic sponsor page 128 to access a white listed electronic page 166 related to credit monitoring service. In this example, the white listed electronic page 166 about the credit monitoring service may be accessible through the electronic sponsor page 128. As another non-limiting example, the user of the client device 150 may select an electronic link on the electronic sponsor page 128 to access an electronic file 168 from a white listed electronic page 166 involving downloading an executable file related to a media content player for the client device 150. In this example, the executable file may be stored on the content server 162 in the computing provider environment 160.

In one example, a server 110 onboard the aircraft 100 may receive a selection of an interface control 132 included in the electronic sponsor page 128. In this example, the interface control 132 may be an electronic link, such as a uniform resource locator (URL), uniform resource indicator (URI), web address, hypertext transfer protocol (HTTP) address, etc. The server 110 may access the white listed electronic page 166 using the associated interface control 132. For example, the server 110 may request access to the white listed electronic page 166 from the content server 162 in the computing provider environment 160. The server 110 may perform the request when the aircraft 100 is in the air. The server 110 on the aircraft 100 may communicate with the content server 162 in the computing provider environment 160 via a satellite 105 and a ground station 107. For example, communications from the server 110 may travel from the aircraft to the satellite 105 and then to the content server 162 via the ground station 107, and vice versa. The content server 162 in the computing provider environment 160 may respond with the requested white listed electronic page 166, and the server 110 onboard the aircraft 100 may send the white listed electronic page 166 to the client device 150. In this configuration, the white listed electronic pages 166 are not stored locally on the aircraft 100, but rather in the computing provider environment 160.

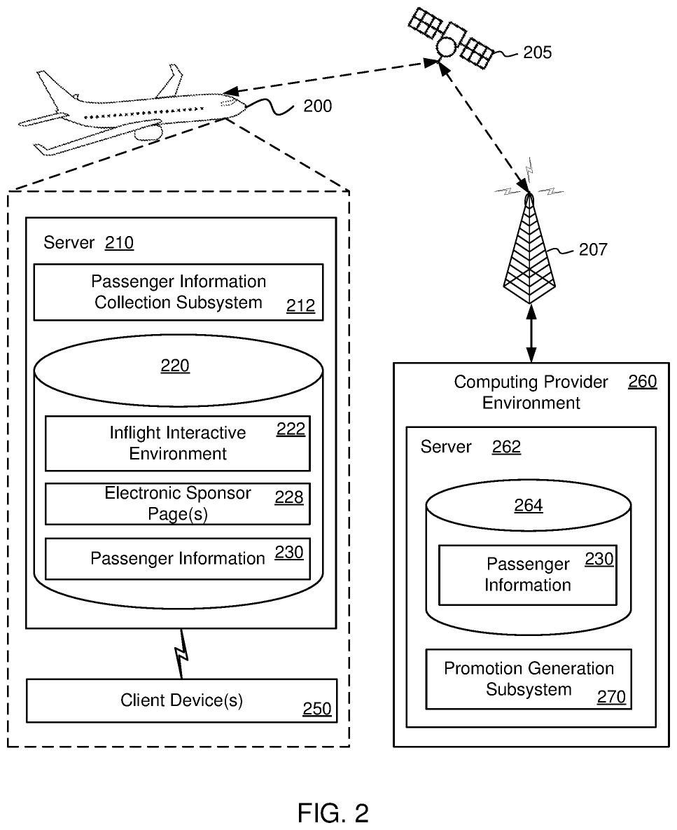

FIG. 2 illustrates an example of a system and related operations for collecting passenger information 230 through an electronic sponsor page 228 and providing the passenger information 230 to a server 262 in a computing provider environment 260. The electronic sponsor page 228 may be accessible through an inflight interactive environment 222. The inflight interactive environment 222 and the electronic sponsor page 228 may be stored in a data store 220 of a server 210 on an aircraft 200. In one example, the server 210 may provide the inflight interactive environment 222 and the electronic sponsor page 228 to a client device 250 on the aircraft. A passenger information collection subsystem 212 of the server 210 may receive the passenger information 230 from the client device 250 via the electronic sponsor page 228. The passenger information 230 may include, but is not limited to, a name, email address, telephone number, mailing address, etc.

In one configuration, the server 210 may offload the passenger information 230 when the aircraft 200 is in the air. For example, the server 210 may send the passenger information 230 to the server 262 in the computing provider environment 260 when the aircraft 200 is in the air. The server 210 may send the passenger information 230 via a satellite 205 and a ground station 207. The server 262 in the computing provider environment 260 may receive the passenger information 230 and store the passenger information 230 in a data store 264 included in the computing provider environment 260. In one example, the server 262 in the computing provider environment 260 may be associated with or operated by a sponsor affiliated with the electronic sponsor page 228.

A promotion generation subsystem 270 operating on the server 262 may offer a promotion or generate a personalized offer for a passenger on the aircraft 200 using the passenger information 230. The promotion or offer may be sent to the client device 250 while the client device 250 is on the aircraft 100, or alternatively, after the aircraft 100 has landed.

In an alternative configuration, the server 210 may send the passenger information 230 when the aircraft 200 is on the ground. In this configuration, rather than sending the passenger information 230 via the satellite 205 and the ground station 207, the server 210 may send the passenger information 230 over a wide area network, such as a cellular communication network after the aircraft 200 has landed on the ground. In this configuration, the promotion generation subsystem 270 may still use the passenger information 230 to offer the promotion or generate the personalized offer for the passenger. In one example, the passenger information 230 may be collected to facilitate a purchase of a service with a recurring fee (e.g., a music streaming service) or other electronic services. For example, a promotion or personalized offer related to the service with the recurring fee may be generated based on the passenger information 230, and the promotion generation subsystem 270 may promote the purchase of the service with the recurring fee by sending the promotion or personalized offer for the service with the recurring fee to the client device 250.

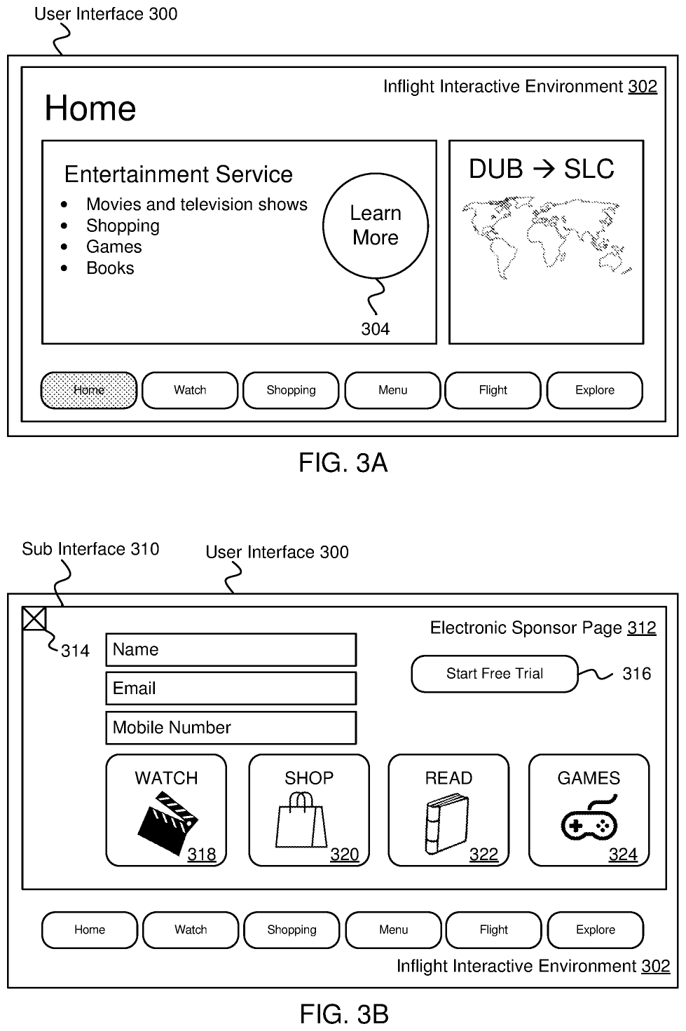

FIG. 3A illustrates an example of a user interface 300 that enables a user to access an inflight interactive environment 302 and an interface control 304 to access an electronic sponsor page. The user may access the inflight interactive environment 302 while onboard an aircraft. In this particular example, the inflight interactive environment 302 may show a home screen. The home screen may include general flight information, as well as interface controls to access other electronic pages for watching media content, shopping, ordering food or drink items, viewing detailed flight information, exploring destination content, etc. In addition, in this example, the inflight interactive environment 302 may include the interface control 304 to access the electronic sponsor page. The interface control 304 may correspond to information about an entertainment service being offered by a sponsor associated with the electronic sponsor page. The entertainment service may offer movies and television shows, shopping, games and books. As shown in FIG. 3A, the inflight interactive environment 302 and the interface control 304 to access the electronic sponsor page may be displayed as part of the user interface 300.

FIG. 3B illustrates an example of a sub interface 310 that enables a user to access an electronic sponsor page 312. For example, when a user selects the interface control 304 on the inflight interactive environment 302 (as shown in FIG. 3A), the electronic sponsor page 312 may be displayed. The electronic sponsor page 312 may be displayed over a sub interface 310 of the user interface 300. For example, the sub interface 310 may appear as an overlay to the user interface 300. The user may interact with the electronic sponsor page 312 via the sub interface 310. For example, the user may enter name information, email information and mobile number information into one or more text boxes displayed on the electronic sponsor page 312, and the user may select a button 316 to start a free trial of an entertainment service. In addition, the user may navigate to other electronic pages that are included in the electronic sponsor page 312. For example, the user may select an interface control 318 to access an electronic page for watching shows, an interface control 320 to access an electronic page for shopping, an interface control 322 to access an electronic page for reading, or an interface control 324 to access an electronic page for gaming. The electronic pages related to watching, shopping, reading and gaming may be incorporated into the electronic sponsor page 312. When the user is finished interacting with the electronic sponsor page 312 through the sub interface 310, the user may select a user interface control 314 to close the sub interface 310 and return to the inflight interactive environment 302 displayed via the user interface 300. Further, the user may return to the electronic sponsor page 312 by selecting the interface control 304 on the home screen, or by selecting a suitable electronic link, button, tab, menu item, etc. on other screens of the inflight interactive environment 302.

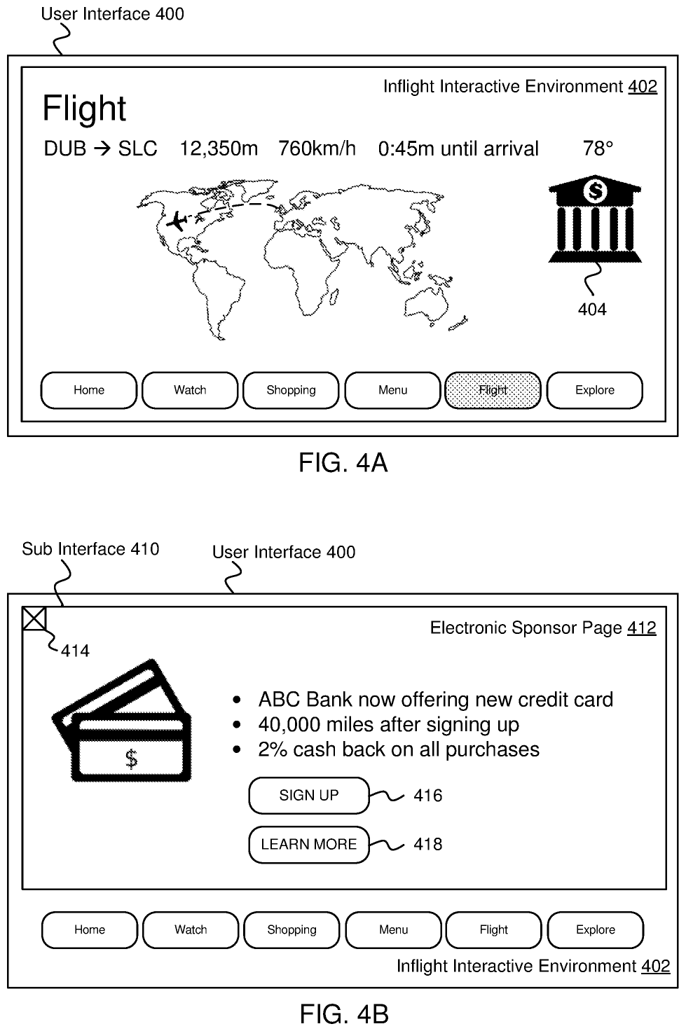

FIG. 4A illustrates an example of a user interface 400 that enables a user to access an inflight interactive environment 402 and an interface control 404 to access an electronic sponsor page. In this particular example, the inflight interactive environment 402 may show a flight information screen. The flight information screen may include information about a flight origin and a flight destination, a current altitude, a current speed and an estimated time until arrival at the flight destination. In addition, the flight information screen may include a moving map that shows the flight's current position. In addition, in this example, the inflight interactive environment 402 may include the interface control 404 to the electronic sponsor page. As shown in FIG. 4A, the interface control 404 may be an image of a banking institution and indicate that an electronic sponsor page affiliated with the banking institution may be accessed via the interface control 404.

FIG. 4B illustrates an example of a sub interface 410 that enables a user to access an electronic sponsor page 412. For example, when a user selects the interface control 404 on the inflight interactive environment 402 (as shown in FIG. 4A), the electronic sponsor page 412 may be displayed via a sub interface 410. The user may interact with the electronic sponsor page 412 via the sub interface 410. For example, the user may read about the benefits of a credit card being offered by the banking institution, select a button 416 to sign up for the credit card, select a button 418 to learn more about the credit card, etc. In this example, the button 416 to sign up for the credit card and the button 418 to access additional information may be electronic links to other electronic pages (e.g., web pages) that are integrated with or are included in the electronic sponsor page 412. Further, when the user is finished interacting with the electronic sponsor page 412 through the sub interface 410, the user may select a button 414 to close the sub interface 410 and return to the inflight interactive environment 402 displayed via the user interface 400.

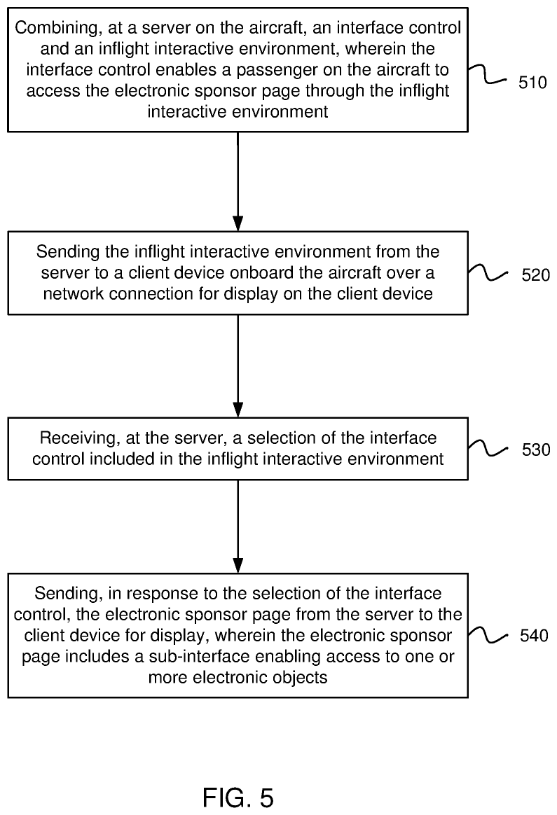

FIG. 5 illustrates an example of a method for providing an electronic sponsor page to passengers on an aircraft. The electronic sponsor page may be provided from a server on the aircraft to a client device on the aircraft. In one example, a network connection between the server and the client device may be a wireless connection established via a wireless access point onboard the aircraft. In another example, the client device may be a seatback system on the aircraft, and the network connection between the server and the seatback system may be a wired or wireless connection.

The server onboard the aircraft may combine an interface control and an inflight interactive environment, as in block 510. The interface control may be associated with an electronic sponsor page. The interface control may enable a passenger on the aircraft to access the electronic sponsor page through the inflight interactive environment. The inflight interactive environment and the electronic sponsor page may be stored on a data store or server on the aircraft.

The server may send the inflight interactive environment to the client device onboard the aircraft over the network connection for display on the client device, as in block 520. The electronic sponsor page may be accessible through the inflight interactive environment. For example, the inflight interactive environment may include a plurality of electronic pages (e.g., web pages or application pages), and an electronic page in the plurality of electronic pages may include an interface control (e.g., an electronic link, button, tab, menu item, etc.) to access the electronic sponsor page. In a specific example, the interface control to access the electronic sponsor page may be included on each electronic page in the plurality of electronic pages of the inflight interactive environment. In addition, the electronic page may display additional interface controls to access a home screen, media content, shopping information, moving map information and/or destination information.

The server may receive a selection of the interface control included in the inflight interactive environment, as in block 530. For example, a user may select the interface control to access the electronic sponsor page on one of the electronic pages in order to access the electronic sponsor page from the inflight interactive environment.

The server may send, in response to the selection of the interface control, the electronic sponsor page to the client device for display, as in block 540. The electronic sponsor page may include a sub-interface enabling access to the one or more electronic objects selected by the sponsor or associated with the sponsor. In one example, the electronic sponsor page may be an activation page that functions to describe to the passengers on the aircraft about a product or a service offered by the sponsor. In another example, the electronic sponsor page may be an acquisition page configured to acquire the passengers on the aircraft as new customers of the sponsor. In yet another example, access to the electronic sponsor page via the inflight interactive environment to passengers on the aircraft may be enabled for a defined period of time based on a marketing campaign duration set by the sponsor.

In one example, the electronic sponsor page may include an interface control to access a white listed electronic page stored on a content server off-board the aircraft. The white listed electronic page may be accessible to the client device via the electronic sponsor page and using an internet connection available onboard the aircraft when the aircraft is in the air. In another example, the electronic sponsor page may include an interface control to access an electronic file provided by a white listed electronic page stored on a content server off-board the aircraft. The electronic file may be accessible to the client device via the electronic sponsor page and using an internet connection available onboard the aircraft. As a non-limiting example, the electronic file may include a media file, executable file, word processing, document, image file, database or spreadsheet file, presentation file, web page, video file, audio file, web application, executable application, etc.

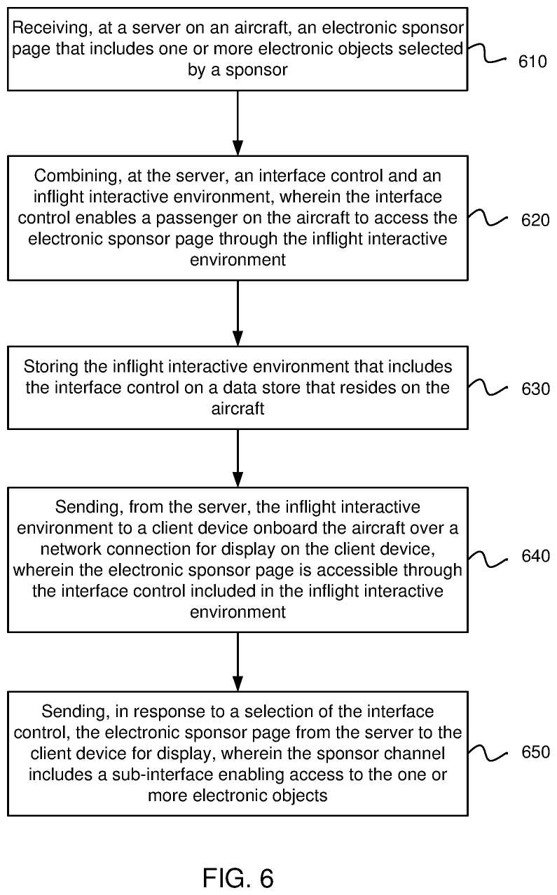

FIG. 6 illustrates an example of a method for providing an electronic sponsor page to passengers on an aircraft. A server onboard the aircraft may receive an electronic sponsor page that includes one or more electronic objects selected by a sponsor, as in block 610. For example, the electronic sponsor page may include electronic objects having audio, video, text, etc. relating to a product or service offered by the sponsor. In addition, the electronic sponsor page may include interface control(s) to more electronic pages.

The server may combine an interface control and an inflight interactive environment, as in block 620. The interface control may be associated with the electronic sponsor page (e.g., a link to the electronic sponsor page or an embedded application that opens another electronic sponsor page). The interface control may enable a passenger on the aircraft to access the electronic sponsor page through the inflight interactive environment

The inflight interactive environment that includes the interface control may be stored on a data store that resides on the aircraft, as in block 630. Further, the electronic sponsor page may be stored on the data store that resides on the aircraft. In one example, the electronic sponsor page may be created and loaded onto the data store that resides on the aircraft when the aircraft is on the ground.

The server may send the inflight interactive environment to a client device onboard the aircraft over a network connection for display on the client device, as in block 640. The electronic sponsor page may be accessible through the interface control included in the inflight interactive environment. For example, the inflight interactive environment may include a plurality of electronic pages, and an electronic page in the plurality of electronic pages may include an interface control to access the electronic sponsor page.

The server may send, in response to the selection of the interface control, the electronic sponsor page to the client device for display, as in block 650. The electronic sponsor page may include a sub-interface enabling access to the one or more electronic objects. The electronic sponsor page may be an activation page to describe a product or a service offered by the sponsor to the passengers on the aircraft, or alternatively, an acquisition page configured to acquire the passengers on the aircraft as new customers of the sponsor.

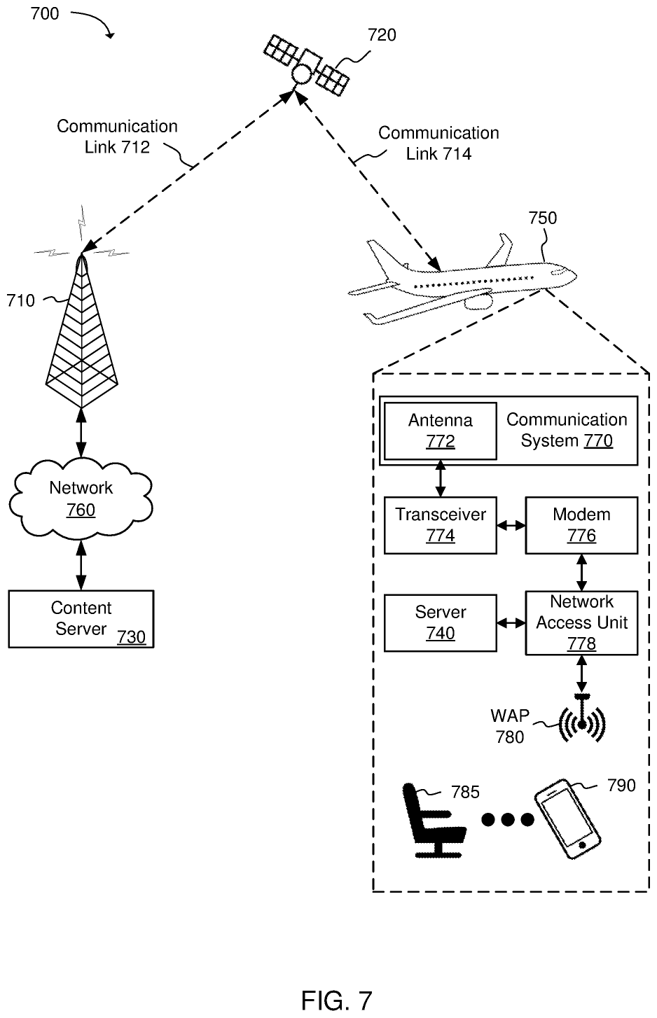

FIG. 7 illustrates an example of a satellite communication system 700. The satellite communication system 700 may include satellite(s) 720 in bidirectional communication with a ground station 710 via a communication link 712 between the satellite 720 and the ground station 710. The satellite 720 may also be in bidirectional communication with an aircraft 750 (e.g., an airplane, helicopter, blimp or balloon) via a communication link 714 between the satellite 720 and the aircraft 750. The communication link 712 and the communication link 714 may enable communication between the aircraft 750 and the ground station 710 via the satellite 720 while the aircraft 750 is stationary or in motion.

In one example, the satellite communication system 700 may include multiple satellites 720, where each satellite 720 may provide coverage for a service area, and service areas for different satellites may be non-overlapping or overlapping. The satellite communication system 700 may be any suitable type of satellite system, including a geostationary satellite system, medium earth orbit satellite system, low earth orbit satellite system, or combinations thereof. The satellite 720 may have a number of beams directed at different regions on Earth, where the coverage area of each beam may be non-overlapping or overlapping with one or more other beams. The satellite 720 may have one or more spot beams covering different regions on Earth within the service area of the satellite 720. As another example, the satellite 720 may have one or more wide area coverage beams covering the service area of the satellite 720. As yet another example, the satellite 720 may have a combination of spot beams and wide area coverage beams.

In one configuration, the aircraft 750 may include a communication system 770 to facilitate bidirectional communication with the satellite 720 via the communication link 714. The communication system 770 may include an antenna 772 to receive a downlink signal from the satellite 720 and transmit an uplink signal to the satellite 720 via the communication link 714. The aircraft 750 may include a transceiver 774 in communication with the antenna 772, a modem 776 in communication with the transceiver 774, a network access unit 778 (e.g., a router) in communication with the modem 776, and a wireless access point (WAP) 780 in communication with the network access unit 778. Further, the wireless access point 780 may communicate with one or more client devices in the aircraft 750, such as seatback systems 785 and/or client devices 790 (e.g., mobile phones, tablets, laptops) in the aircraft 750. Therefore, the communication system 770 may receive a downlink signal from the satellite 720 and forward the downlink signal to the client devices, and receive an uplink signal from the client devices and forward the uplink signal to the satellite 720, thereby supporting two-way data communications between the client devices within the aircraft 750 and the satellite 720.

In one configuration, the network access unit 778 may be in communication with a server 740 (such as the server 110 described earlier) onboard the aircraft 750. The server 740 may combine an interface control and an inflight interactive environment. The interface control may be associated with an electronic sponsor page and enable a passenger on the aircraft 750 to access the electronic sponsor page through the inflight interactive environment via a user interface. The server 740 may send the inflight interactive environment to the client device 790 onboard the aircraft 750 over a network connection for display via the user interface of the client device 790. The server 740 may receive a selection of the interface control included in the inflight interactive environment via the user interface. The server 740 may send the electronic sponsor page to the client device 790 for display in response to the selection of the interface control. The electronic sponsor page can include a sub-interface enabling access to one or more electronic objects.

In one example, the seatback system 785 may be a fixed or on-aircraft device. The seatback system 785 may communicate with the server 740 via a wired communication link. For example, the seatback system 785 may communicate with the network access unit 778 over a wired communication link, and the network access unit 778 may communicate with the server 740 over a wired communication link. Alternatively, the seatback system 785 may communicate with the server 740 via the network access unit 778 and the wireless access point 780. The seatback system 785 may execute one or more applications that provide an interface for users on the aircraft 750 to obtain and consume data.

In one example, the client device 790 may receive and display data, and may be brought onto the aircraft 750 by users (which include passengers or crew members). The client devices 790 may execute one or more applications that provide the interface for users to obtain and consume data. The user may have the option to select/request data for viewing from the interface. When a user interacts with the client device 790, the client device 790 may transmit a request for data to the network access unit 778 via the wireless access point 780. The client device 790 may receive requested data from the network access unit 778 via the wireless access point 780. Thus, the wireless access point 780 may provide communication between the network access unit 778 and personal electronic device 790.

In one example, the network access unit 778 may receive requests for data from the client device 790 via the wireless access point 780 and multiplex and forward the requests to the modem 776. The network access unit 778 may receive and demultiplex packets associated with the data, and forward the data to the client device 790 via the wireless access point 780.

In one example, the modem 776 may receive requests for data from the network access unit 778, and the modem 776 may generate modulated data (e.g., a transmit intermediate frequency (IF) signal) for delivery to the transceiver 774. Further, the modem 776 may receive requested data as a modulated data (e.g., a receive intermediate frequency (IF) signal) from the transceiver 774 and demodulate that data for transmission to the network access unit 778. In one example, the modem 776 may be integrated with the network access unit 778, or alternatively, the modem 776 and the network access unit 778 may be separate components.

In one example, the transceiver 774 may up-convert and amplify modulated data received from the modem 776 to generate an uplink signal for transmission to the satellite 720 via the antenna 772. Similarly, the transceiver 774 may receive a downlink signal from the satellite 720 via the antenna 772. The transceiver 774 may then amplify and down-convert the downlink signal to generate modulated downlink data (e.g., a receive IF signal) for demodulation by the modem 776.

In one example, the ground station 710 may also be referred to as an access node, a hub or a gateway. The ground station 710 may include an antenna to transmit an uplink signal to the satellite 720 and receive a downlink signal from the satellite 720. The ground station 710 may be in communication with a content server 730 via a network 760. The content server 730 may include an inflight interactive environment having a plurality of electronic pages and an electronic sponsor page, as described above with respect to FIGS. 1A and 1B. In addition, the content server 730 may include electronic advertisements, media content, web content, etc.

In one example, the network 760 may be any type of network and may include for example, an internet, an internet protocol (IP) network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein. The network 760 may include both wired and wireless connections as well as optical links.

In one example, the ground station 710 may be provided as an interface between the network 760 and the satellite 720. The ground station 710 may receive data and information directed to the seatback system 785 and/or the client device 790 onboard the aircraft 750 from the content server 730 accessible via the network 760. The ground station 710 may format the data and information and transmit an uplink signal to the satellite 720 for subsequent delivery to the aircraft 750 (and then the seatback system 785 and/or the client device 790) Similarly, the ground station 710 may receive a downlink signal from the satellite 720 (e.g., containing requests, data and/or information originating from the seatback system 785 and/or the client device 790 on the aircraft 750) that is directed to a destination accessible via the network 760. The ground station 710 may format the received downlink signal for transmission on the network 760.

In one configuration, the seatback system 785 and/or the client device 790 may be onboard the aircraft 750. Alternatively, the seatback system 785 and/or the client device 790 may be onboard other types of vehicles, such as trains, automobiles (e.g., cars, trucks, busses, etc.), watercraft (e.g., private boats, commercial shipping vessels, cruise ships, etc.) and others.

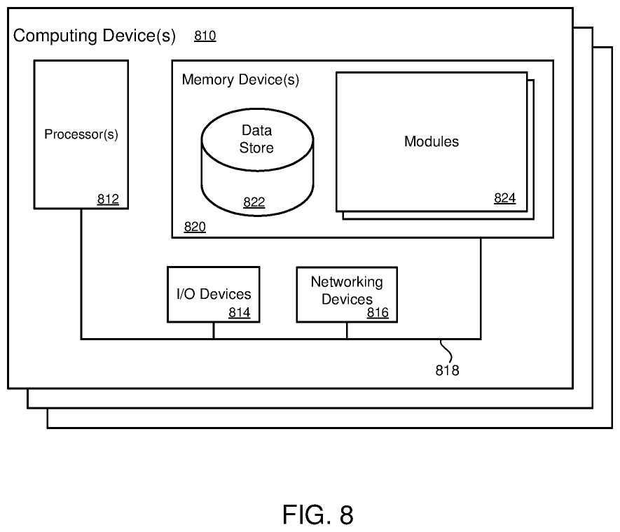

FIG. 8 illustrates a computing device 810 which may execute the foregoing subsystems of this technology. The computing device 810 and the components of the computing device 810 described herein may correspond to the servers and/or client devices described above. The computing device 810 is illustrated on which a high level example of the technology may be executed. The computing device 810 may include one or more processors 812 that are in communication with memory devices 820. The computing device may include a local communication interface 818 for the components in the computing device. For example, the local communication interface may be a local data bus and/or any related address or control busses as may be desired.

The memory device 820 may contain modules 824 that are executable by the processor(s) 812 and data for the modules 824. The modules 824 may execute the functions described earlier. A data store 822 may also be located in the memory device 820 for storing data related to the modules 824 and other applications along with an operating system that is executable by the processor(s) 812.

Other applications may also be stored in the memory device 820 and may be executable by the processor(s) 812. Components or modules discussed in this description that may be implemented in the form of software using high programming level languages that are compiled, interpreted or executed using a hybrid of the methods.

The computing device may also have access to I/O (input/output) devices 814 that are usable by the computing devices. An example of an I/O device is a display screen that is available to display output from the computing devices. Other known I/O device may be used with the computing device as desired. Networking devices 816 and similar communication devices may be included in the computing device. The networking devices 816 may be wired or wireless networking devices that connect to the internet, a LAN, WAN, or other computing network.

The components or modules that are shown as being stored in the memory device 820 may be executed by the processor 812. The term “executable” may mean a program file that is in a form that may be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be random access memory (RAM), read only memory (ROM), flash memory, a solid state drive, memory card, a hard drive, optical disk, floppy disk, magnetic tape, or any other memory components.

The processor 812 may represent multiple processors and the memory 820 may represent multiple memory units that operate in parallel to the processing circuits. This may provide parallel processing channels for the processes and data in the system. The local interface 818 may be used as a network to facilitate communication between any of the multiple processors and multiple memories. The local interface 818 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for providing electronic sponsor pages to passengers on an aircraft, comprising:
combining, at a server on the aircraft, an interface control and an inflight interactive environment, wherein the interface control enables a passenger on the aircraft to access an electronic sponsor page through the inflight interactive environment;
sending the inflight interactive environment from the server to a client device onboard the aircraft over a network connection for display;
receiving, at the server, a selection of the interface control included in the inflight interactive environment; and
sending, in response to the selection of the interface control, the electronic sponsor page from the server to the client device for display, wherein the electronic sponsor page includes a sub-interface enabling access to one or more electronic objects.

2. The method of claim 1, wherein the inflight interactive environment includes a plurality of electronic pages, and each electronic page in the plurality of electronic pages includes an interface control to access the electronic sponsor page.

3. The method of claim 1, wherein the inflight interactive environment includes a plurality of electronic pages, and each electronic page in the plurality of electronic pages displays additional interface controls to access at least one of: a home screen, media content, shopping information, moving map information, or destination information.

4. The method of claim 1, further comprising storing the inflight interactive environment that includes the interface control and the electronic sponsor page on a data store or server on the aircraft.

5. The method of claim 1, further comprising:
receiving the electronic objects from a sponsor;
including the electronic objects in the electronic sponsor page; and
loading the electronic sponsor page onto a data store on the aircraft when the aircraft is on the ground.

6. The method of claim 1, wherein the electronic sponsor page is an activation page that describes a product or a service offered by a sponsor.

7. The method of claim 1, wherein the electronic sponsor page is an acquisition page configured to acquire the passengers on the aircraft as new customers of a sponsor.

8. The method of claim 1, wherein the electronic sponsor page includes an interface control to access a white listed electronic page stored on a content server off-board the aircraft, wherein the white listed electronic page is accessible to the client device via the electronic sponsor page and using an internet connection available onboard the aircraft when the aircraft is in the air.

9. The method of claim 1, wherein the electronic sponsor page includes an interface control to access an electronic file provided by a white listed electronic page stored on a content server off-board the aircraft, wherein the electronic file is accessible to the client device via the electronic sponsor page and using an internet connection available onboard the aircraft.

10. The method of claim 1, further comprising:
receiving passenger information from the client device using the electronic sponsor page; and
forwarding the passenger information to a server associated with a sponsor when the aircraft is in the air or after the aircraft has landed on the ground, wherein the passenger information enables the sponsor to provide a promotional offer related to a service with a recurring fee to passengers on the aircraft.

11. The method of claim 1, further comprising enabling access to the electronic sponsor page via the inflight interactive environment to passengers on the aircraft for a defined period of time based on a marketing campaign duration set by a sponsor.

12. The method of claim 1, wherein the network connection between the server and the client device is a wireless connection established via a wireless access point onboard the aircraft.

13. The method of claim 1, wherein the client device is a seatback system on the aircraft, and the network connection between the server and the seatback system is a wired or wireless connection.

14. A non-transitory machine readable storage medium having instructions embodied thereon, the instructions when executed by one or more processors, cause the one or more processors to perform a process including:
receiving, at a server on an aircraft, an electronic sponsor page that includes one or more electronic objects;
combining, at the server, an interface control and an inflight interactive environment, wherein the interface control is associated with the electronic sponsor page and enables a passenger on the aircraft to access the electronic sponsor page through the inflight interactive environment
storing the inflight interactive environment that includes the interface control on a data store that resides on the aircraft;
sending, from the server, the inflight interactive environment to a client device onboard the aircraft over a network connection for display on the client device, wherein the electronic sponsor page is accessible through the interface control included in the inflight interactive environment; and
sending, in response to a selection of the interface control, the electronic sponsor page from the server to the client device for display, wherein the electronic sponsor page includes a sub-interface enabling access to the one or more electronic objects.

15. The non-transitory machine readable storage medium of claim 14, wherein the inflight interactive environment includes a plurality of electronic pages, and each electronic page in the plurality of electronic pages includes an interface control to access the electronic sponsor page.

16. The non-transitory machine readable storage medium of claim 14, wherein the inflight interactive environment includes a plurality of electronic pages, and each electronic page in the plurality of electronic pages displays additional interface controls to access at least one of: a home screen, media content, shopping information, moving map information, or destination information.

17. The non-transitory machine readable storage medium of claim 14, wherein the electronic sponsor page is created and loaded onto the data store that resides on the aircraft when the aircraft is on the ground.

18. The non-transitory machine readable storage medium of claim 14, wherein the electronic sponsor page is an activation page that describes a product or a service offered by a sponsor.

19. The non-transitory machine readable storage medium of claim 14, wherein the electronic sponsor page is an acquisition page configured to acquire passengers on the aircraft as new customers of a sponsor.

20. The non-transitory machine readable storage medium of claim 14, wherein the electronic sponsor page includes an interface control to access a white listed electronic page stored on a content server off-board the aircraft, wherein the white listed electronic page is accessible to the client device via the electronic sponsor page and using an internet connection available onboard the aircraft when the aircraft is in the air.

21. The non-transitory machine readable storage medium of claim 14, wherein the electronic sponsor page includes an interface control to access an electronic file provided by a white listed electronic page stored on a content server off-board the aircraft, wherein the electronic file is accessible to the client device via the electronic sponsor page and using an internet connection available onboard the aircraft.

22. The non-transitory machine readable storage medium of claim 14, further comprising:
receiving passenger information from the client device using the electronic sponsor page; and
forwarding the passenger information to a server associated with a sponsor when the aircraft is in the air or after the aircraft has landed on the ground, wherein the passenger information enables the sponsor to provide a promotional offer related to a service with a recurring fee to passengers on the aircraft.

23. The non-transitory machine readable storage medium of claim 14, further comprising: enabling access to the electronic sponsor page via the inflight interactive environment to passengers on the aircraft for a defined period of time based on a marketing campaign duration set by a sponsor.

24. The non-transitory machine readable storage medium of claim 14, wherein the network connection between the server and the client device is a wireless connection established via a wireless access point onboard the aircraft.

25. The non-transitory machine readable storage medium of claim 14, wherein the client device is a seatback system on the aircraft, and the network connection between the server and the seatback system is a wired or wireless connection.

26. A system, comprising:
at least one processor; and
at least one memory device including a data store to store a plurality of data and instructions that, when executed, cause the system to:
combine an interface control and an inflight interactive environment, wherein the interface control is associated with an electronic sponsor page and enables a passenger on an aircraft to access the electronic sponsor page through the inflight interactive environment;
send the inflight interactive environment to a client device onboard the aircraft over a network connection for display on the client device;
receive a selection of the interface control included in the inflight interactive environment; and
send, in response to the selection of the interface control, the electronic sponsor page to the client device for display, wherein the electronic sponsor page includes a sub-interface enabling access to one or more electronic objects.

27. The system of claim 26, wherein the inflight interactive environment includes a plurality of electronic pages, and each electronic page in the plurality of electronic pages includes an interface control to access the electronic sponsor page.

28. The system of claim 26, wherein the inflight interactive environment includes a plurality of electronic pages, and each electronic page in the plurality of electronic pages displays additional interface controls to access at least one of: a home screen, media content, shopping information, moving map information, or destination information.

29. The system of claim 26,
wherein the plurality of data and instructions, when executed, cause the system to:
receive the electronic objects from a sponsor;
add the electronic objects to the electronic sponsor page; and
load the electronic sponsor page onto a data store that resides on the aircraft when the aircraft is on the ground.

30. The system of claim 26, wherein the electronic sponsor page is an activation page that describes a product or a service offered by a sponsor.

31. The system of claim 26, wherein the electronic sponsor page is an acquisition page configured to acquire passengers on the aircraft as new customers of the sponsor.

32. The system of claim 26, wherein the electronic sponsor page includes an interface control to access a white listed electronic page stored on a content server off-board the aircraft, wherein the white listed electronic page is accessible to the client device via the electronic sponsor page and using an internet connection available onboard the aircraft when the aircraft is in the air.

33. The system of claim 26, wherein the electronic sponsor page includes an interface control to access an electronic file provided by a white listed electronic page stored on a content server off-board the aircraft, wherein the electronic file is accessible to the client device via the electronic sponsor page and using an internet connection available onboard the aircraft.

34. The system of claim 26, wherein the plurality of data and instructions, when executed, cause the system to:
receive passenger information from the client device using the electronic sponsor page; and
forward the passenger information to a server associated with a sponsor when the aircraft is in the air or after the aircraft has landed on the ground, wherein the passenger information enables the sponsor to provide a promotional offer related to a service with a recurring fee to passengers on the aircraft.

35. The system of claim 26, wherein the plurality of data and instructions, when executed, cause the system to: enable access to the electronic sponsor page via the inflight interactive environment to passengers on the aircraft for a defined period of time based on a marketing campaign duration set by a sponsor.

36. The system of claim 26, wherein the client device is a seatback system on the aircraft.
